(19) United States
(12) Patent Application Publication
(10) Pub. No.: US 2017/0071228 A1
(43) Pub. Date: Mar. 16, 2017

(54) ARRANGEMENT INTRODUCED IN MACHINE FOR VENDING ICE CREAMS AND OTHERS

(71) Applicant: TOPEMA COZINHAS PROFISSIONAIS INDUSTRIA E COMERCIO LTDA., DIADEMA, ESTADO DE PAULO (BR)

(72) Inventor: Nelson FERRAZ CURY, DIADEMA (BR)

(21) Appl. No.: 15/120,235

(22) PCT Filed: Jan. 7, 2016
(86) PCT No.: PCT/BR2016/000001

§ 371 Date: Aug. 19, 2016

(30) Foreign Application Priority Data
Jan. 13, 2015 (BR) 20 2015 000752 9

(51) Int. Cl. A23G 9/28; G07F 13/10; A23G 9/22

(52) U.S. Cl. CPC A23G 9/28; A23G 9/22; G07F 13/10

(57) ABSTRACT

A vending machine is provided for the unattended selling of products to consumers, for example, for selling ice creams. The vending machine includes one single cabinet having lower, intermediate and top portions; a inferiorly closed hinged front door incorporating a wide showcase; and rear man doors. The single cabinet and front door house and feature a set of components required for vending ice creams or other products, and for that purpose include an ice cream manufacturing assembly; containers of complements and cups; a robotic arm and user interface devices. The user interface devices include a touchscreen monitor; a payment device; a spoon dispenser; a device for delivering the ice cream; a monitor; an electronic control housing; a backlight; and a shelf-like adapter that may be used instead of the ice cream machine for optionally vending other products.

The present invention relates to a utility model application for a vending machine pertaining to the field of automatic vending machines intended for the unattended selling of products to consumers, said machine having been the object of an arrangement particularly for selling ice creams in order to overcome the disadvantages of conventional ice cream vending machines, and also to be adaptable to sell other edible products, so that it is obtained a universal vending machine of edible products, such as ice cream, candies, appetizers and others.

One of the techniques employed to sell products to consumers is the one that uses automatic vending machines set up in places with a high traffic of people, such machines including features required to the achievement of sales, such as: list of products available for sale; device for the user to choose items from the list; device for payment; devices for composition, if this is the case, and dispensing the product; device for delivering the product, visual communication devices among others. Machines of this type are employed, particularly, in the automatic sale of food and drink items which can be consumed immediately by the consumer.

It is already known in the art an ice cream vending assembly comprised essentially of: a conventional soft ice cream machine; and an automatic vending unit that is simply juxtaposed in front of the ice cream machine and contains: devices for a user to choose a type of ice cream from a list and pay; canisters with different ingredients that may composed the ice cream; a deposit for supplying cups or “cones”; a robotic arm that picks up a cup or “cone” and passes it through the ice cream machine and canisters of ingredients as programmed; and a device for dispensing the ice cream composed.

While such conventional assembly complies with its purpose, it has the disadvantage of being formed by two units, i.e. the rear ice cream machine and the front vending unit, which form a bulk equipment, which makes more difficult or even impossible to set up the vending machine in certain places, such as, for example, in shopping malls. This drawback is related to the bulk volume of the machine that requires a relatively large and expensive area for installation, a requirement that inevitably is reflected in the final cost of the product. However, places such as shopping malls, amusement parks and the like are the places most requiring this type of machine. Another disadvantage of this type of equipment is related to the difficulty to perform operations such as maintenance, re-filling, cleaning of the site among others, because two large size units have to be “handled”. Thus, new solutions for this type of equipment are desirable.

Furthermore, these ice cream vending assemblies have not shown to be suitable for use in very hot environments.

One of the characteristics of the ice cream supplied through this assembly is to have a “heavy” appearance not always pleasing to most people.

Given the characteristics of the robotic arm, these conventional assemblies may be undesirably more expensive.

Therefore, the object of the present invention is to provide an ice cream vending machine capable of overcoming the limitations and disadvantages of conventional ice cream vending machines mainly as regards the large area required for their installation.

Another object of the present invention is to provide a machine that is efficient even in very hot environments, and provide a better quality product.

Another object of the invention is to provide a machine relatively simple to construct and manufacture.

Another object is to provide a low purchase, operation and maintenance cost machine.

Therefore, in view of the aforementioned drawbacks and in order to overcome them and accomplish the related objects, the arrangement introduced in the machine for vending ice cream or other products object of the present patent comprises one single cabinet having lower, intermediate and top portions; a inferiorly hinged closed front door and a large display that shows the intermediate and top portions of the cabinet; rear man doors, said cabinet and front door housing all components necessary for the storage, preservation and arrangement on hold of ice cream ingredients or others; for the storage and arrangement on hold of the utensils required for serving and consuming ice creams or other products; for the user interface; for the composition of ice creams or other products; and for the delivery of the ice cream or other products to the user.

Such machine when mounted for vending ice creams essentially comprises: at the bottom of the cabinet: a cooler for the syrup; a compressor for manufacturing the ice cream; an electric housing; and a basis for supporting these components and mounting casters; in the rear portion of the cabinet: a peristaltic pump and aerator assembly, and the motor and transmission assembly of the ice cream machinery; in the intermediate portion of the cabinet: a centrally arranged ice cream machine assembly (cylinders); canisters for dispensing solid ingredients and a cup dispenser laterally positioned to the ice cream machine; a robotic arm; and a lower tray to collect leftovers; at the door: a touch screen selection display; a payment mechanism; a spoon dispenser; and a device for delivering the ice cream; in the top portion of the cabinet said machine further comprises: a display for advertising and/or displaying other messages; an electronic control housing; a ventilation system; and in the upper portion of the door: a backlight.

The machine thus constructed overcomes the drawbacks of the conventional assembly, because despite of containing all components necessary for serving and vending ice creams, as this, and additional components, it has a smaller volume and requires less installation area, thereby occupying less space and having a lower rent cost in shopping malls and the like.

On the other hand, as the present machine is formed by one single unit its inside can be accessed from the front and/or rear hinged doors, which facilitates maintenance, cleaning, replacement and other operations required during use. Furthermore, the machine is a single unit supported on casters, which facilitates moving it to other locations or through narrower passageways, making easier “handling” it at the installation site.

The machine further incorporates a syrup cooling and ice cream aeration device that enables using the machine even in very hot environments, and provide a “light” product according to the taste of most people.

Another concern observed in the development of this machine compared to the conventional assembly was to obtain a machine capable of performing all the operations required and still be inexpensive. For such purpose, the construction and manufacture of the whole structure of the machine, especially its robotic arm (object of another patent application by the same applicant), are less complex and expensive than the conventional machine, in accordance with the other objectives of the arrangement.

The attached drawings refer to the arrangement introduced in the machine for vending ice cream and other products, object of the present patent, in which:

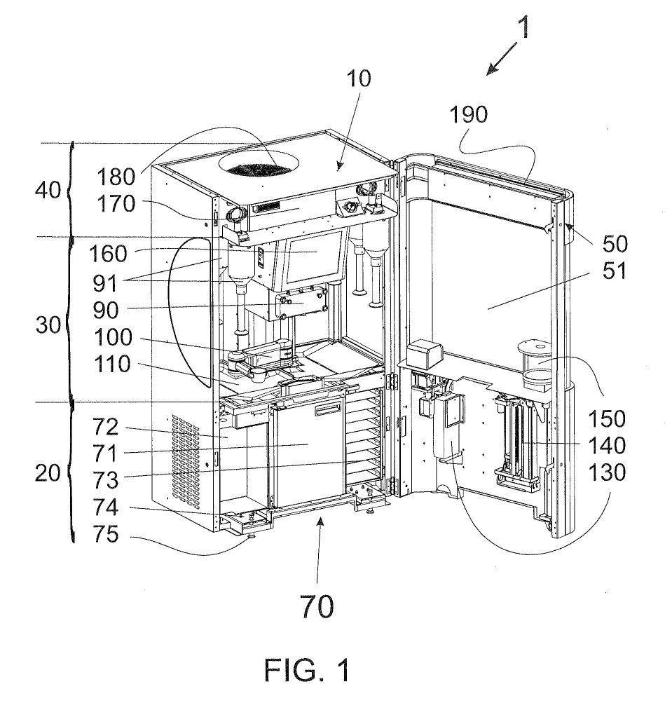

FIG. 1 shows a front perspective view of the machine for vending ice cream and other products and with the door open;

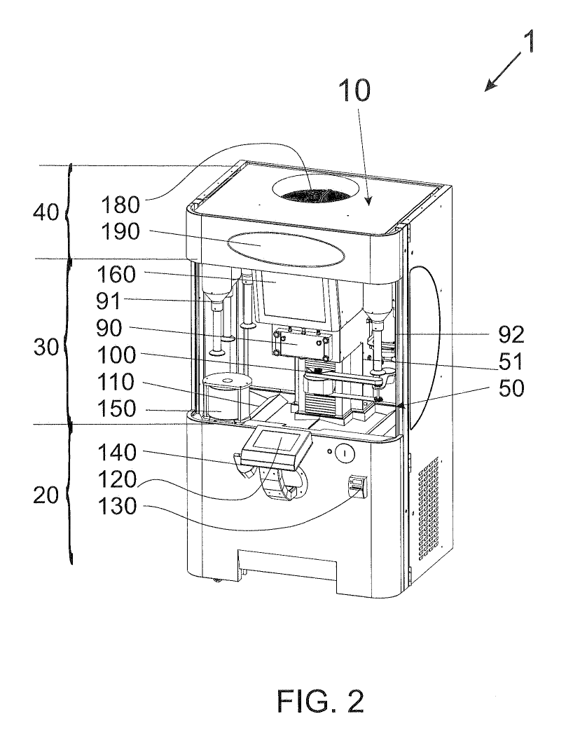

FIG. 2 shows the same view of FIG. 1 with the door closed;

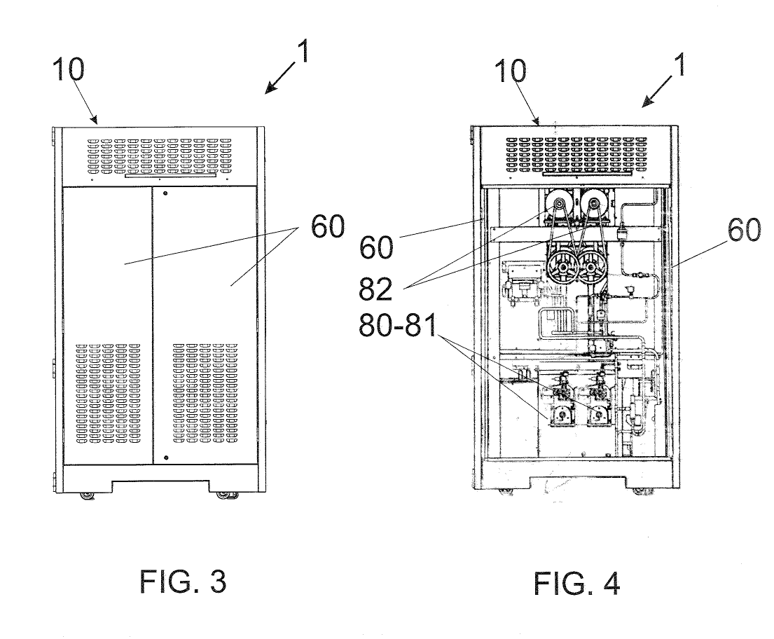

FIGS. 3 and 4 show a rear view of the machine with the man doors closed and open, respectively;

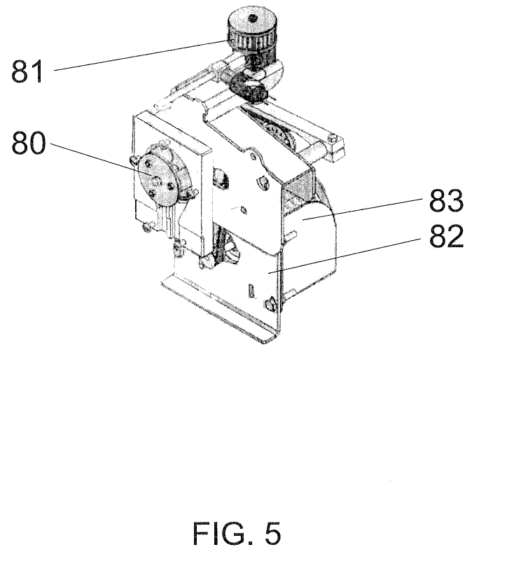

FIG. 5 shows a detail of the peristaltic pump and aerator assembly, which is part of the machine;

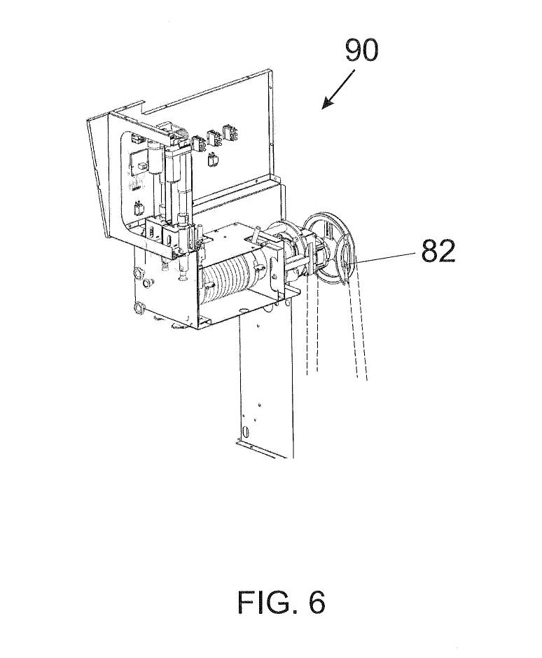

FIG. 6 shows an enlarged section detail of an ice cream manufacturing machine (cylinder);

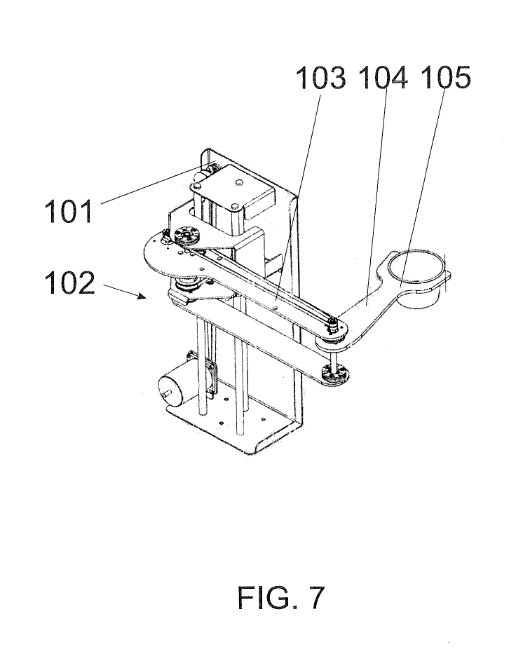

FIG. 7 shows an isolated perspective view of the robotic arm of the machine; and

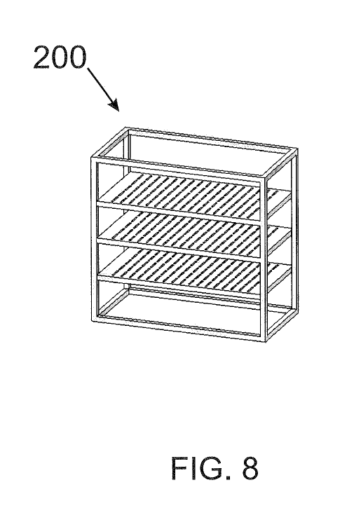

FIG. 8 shows a shelf for use when the machine is programmed to sell products other than ice cream.

As shown in the above figures and provided in the arrangement, the machine 1 object of this patent is intended above all for automatically vending ice cream and can be programmed to sell other food or drink or other items.

Thus, the machine 1 is essentially comprised of (FIGS. 1, 2) one single cabinet 10 having lower 20, intermediate 30 and top 40 portions; a inferiorly closed hinged front door 50 and incorporating a wide showcase 51, which shows the intermediate 30 and top 40 regions of the cabinet; rear man doors 60, such cabinet 10 and front door 50 housing and featuring a set of components 70 required for vending ice creams or other products.

The referred to machine 1 when mounted for vending ice cream has an assembly 70 essentially comprising: at the bottom 20 of the cabinet: a cooler for the syrup 71 and a compressor assembly 72 for the cooling system of the ice cream manufacturing system; an electric component board 73; and a basis 74 for supporting such components, a cabinet 10 and casters 75 to move the equipment.

In the rear portion of the cabinet, and accessible through a man door 60, said machine 1 comprises other components of the ice cream manufacturing system, particularly (FIGS. 3, 4): a peristaltic pump 80 and aerator 81 assembly, which pumps the syrup to the ice cream machine (cylinder) and incorporates air, and the top motor and transmission assembly 82 of the ice cream machine.

In the intermediate portion 30 of the cabinet, the ice cream manufacturing system of machine 1 comprises (FIGS. 1, 2): a centrally arranged ice cream manufacturing machine (cylinders) assembly 90, which receives the aerated syrup, and produces and dispenses the ice cream servings; canisters 91 for dispensing solid ingredients (toppings) to complement the ice cream, and a cup dispenser 92 located laterally to the ice cream machine; a robotic arm 100 arranged in front of the ice cream machine 90, for mixing the ice cream as programmed, and which, at each operation programmed by the user (ice cream purchaser) takes a cup, a serving of soft ice cream and the ingredients; and a lower tray 110 to collect the leftovers occasionally falling from the dispensers.

At the front door 50, the machine 1 comprises: a user interface touchscreen monitor 120 to select the product for purchase; a payment device 130; a spoon dispenser 140; and a device for delivering the ice cream 150 when ready.

The top 40 of the cabinet of said machine 1 further comprises: a monitor for advertising and/or displaying other messages 160; electronic control housing 170; ventilation system 180 for the cooling system of the ice cream manufacturing system; and at the bottom of the front door 50: a backlight 190.

In details: the syrup cooler 71 has a front door accessible through the cabinet door 50 when open, and all the cold necessary for the production of an ice cream is generated by the cooling system (compressor, evaporator, condenser, others) mounted in the equipment itself.

The peristaltic pump 80 and aerator 81 are mounted to a support assembly 82 (FIG. 5). Thus, the following is mounted on such support: a motor and transmission assembly 83; the crushing rotor 84 of the hose (not shown) that is part of the peristaltic pump 80; and an assembly consisting of: eccentric, arm subjected to the eccentric, bellows subjected to the arm, environment air intake filter, and valve connected to the pumping circuit forming the aerator 81.

The ice cream machine 90 is conventionally comprised of (FIG. 6): a cylinder housing a device to whip and mix the soft ice cream (not shown) subject to the motor and transmission assembly 82; a cooling coil located outside the cylinder; and a front ice cream dispensing valve assembly.

The ingredient dispensing canisters 91 are of a silo type whose upper portion is intended to store the ingredients, and a lower outlet opening featuring a laid that opens when the robotic arm is positioned under it. The cup dispenser 92 is a deposit that dispenses a cup when the robotic arm is positioned under it.

The construction of the robotic arm 100 is simple and complies with its function; furthermore, it is the object of another patent application by the same applicant, and essentially comprises (FIG. 7): a column 101 housing an arm lifting and moving mechanism (motorization, transmission, guides) 102; an arm formed by two sections: the first 180° arm section 103 is articulated in respect of column 101; and the second 360° arm section 104 is articulated in respect of the first, the free end thereof featuring a finger 105 to grip the ice cream cup.

The tray 110 is the lower cover of the intermediate portion 30 of the cabinet and has inclined surfaces and channels under the dispensers 91 to collect and move leftovers that may fall during the ice cream preparation.

The user interface devices provided in the door 50 comprise a touchscreen monitor 120 displaying the list of items available for the user to select for composition of the ice cream associated with onscreen selection means. The payment device 130 is a device capable of receiving a token and/or coin and/or money bill. The spoon dispenser 140 is object of another patent application by the same applicant and substantially comprises a deposit provided to dispense plastic spoons commonly used to have ice creams. The ice cream delivery device 150 substantially comprises a rotary cylindrical receptacle, the wall thereof having an opening to receive and deliver the ice cream, said opening being turned inwardly the cabinet 10, after preparation, to receive the ice cream, turn and place it at a position accessible by the user that purchased the ice cream, and after the user takes the ice cream, it goes back to its initial position.

The logic of operation of the ice cream vending machine 1 is controlled by a dedicated electronic control board 170 (computer) mounted to a case in the top portion 40 of the cabinet.

Thus, when in operation, a buyer “mounts” his/her own ice cream with the help of the touchscreen monitor 120, pays for the product by using the payment device 130, and the information is sent to the electronic board 170. Next, the robotic arm 100 starts to move, first to the cup dispenser 92, where it picks up a cup, then to the ice cream machine 90 where it is positioned to receive the ice cream serving selected, and then goes through the canisters 91 of complementary ingredient selected to complete the ice cream “assembly”, and all of that can be seen through the window built into the door 50. After assembly, the arm 100 places the ice cream ready in the delivery device 150 located at the door 50 to deliver it to the user, and the spoon dispenser 140 simultaneously dispenses a spoon for consumption of the ice cream, thus the operation is substantially complete, after which the machine 1 is ready for a new operation cycle.

The monitor 160 and backlight 190 show audio and visual playful messages on the products sold and/or others that can be stored in the system or loaded from a remote place.

All maintenance, cleaning, refilling and other operations are made by opening the front 50 and rear 60 doors to access the parts of the equipment. The machine 1 can be moved with the help of casters 75 for any work required to be made in the area where it is installed, such as cleaning and others. The front door 50 provides a 180° opening such that the width of the equipment, from front to rear can be reduced to facilitate passing through tight spaces.

According to the basic construction disclosed above, it should be appreciated that the machine 1 for vending ice creams or other products object of the present patent may be subject to changes in materials, dimensions, functional or ornamental configuration without departing from the scope of the protection claimed.

In addition, as already mentioned herein the machine 1 can be programmed to vend other products, particularly food or drinks, when an adapted shelf 200 (FIG. 8) can be mounted at the site of the ice cream machine 90. All operational logic of the equipment stored in the electronic board control 170 is reprogrammed according to the product(s) sold.

1. A machine for vending ice creams and other products, comprising:
a structure;
an assembly of devices for storing and providing the ice dream and other products to be sold or vended; and
user interface devices for purchasing the ice cream and other products;
wherein the structure comprises:
one single cabinet having lower, intermediate and upper portions;
an inferiorly closed hinged front door incorporating a wide showcase, which wide showcase shows the intermediate and top portions of the cabinet; and
rear man doors;
wherein the cabinet and front door house and feature a set of components required for vending ice creams, which set of components comprise:
at the lower portion of the cabinet: a cooler for the syrup and a compressor assembly for a cooling system of the ice cream manufacturing system;
an electric component board; and
a basis for supporting such components, a cabinet and casters;
in the cabinet rear part accessed through the man door, an ice cream manufacturing system, including: a peristaltic pump and aerator assembly that pumps the syrup to the ice cream machine and incorporates air and a top motor and transmission assembly of the ice cream machine;
in the intermediate portion of the cabinet, the ice cream manufacturing system comprises:
a centrally arranged ice cream manufacturing machine assembly including cylinders, which ice cream manufacturing machine assembly receives the syrup aerated by the aerator assembly and produces and dispenses ice cream servings;
canisters for dispensing solid ingredients including toppings to complement the ice cream, and a cup dispenser located laterally to the ice cream machine;
a robotic arm arranged in front of the ice cream machine for preparing the ice cream, which robotic arm, at each operation and as programmed by a user, takes a cup, a soft ice cream serving and the solid ingredients; and
a lower tray to collect the leftovers;
at the front door: a user interface touchscreen monitor to select the product to be sold or vended;
a payment device;
a spoon dispenser; and
a device for delivering the ice cream;
in the top portion of the cabinet:
a monitor;
an electronic control housing;
a ventilation system for the cooling system of the ice cream manufacturing system; and
in the upper portion of the front door: a backlight.

2. The machine for vending ice creams and other products according to claim 1, wherein a shelf-like adapter is used instead of the ice cream machine, which shelf-like adapter adapts the machine for vending other products, such as food and drinks.
